(19) United States
(12) Patent Application Publication
(10) Pub. No.: US 2012/0067128 A1
(43) Pub. Date: Mar. 22, 2012

(54) Ultrasonic Testing System

(75) Inventors: Dietmar Oberhoff, Leichlingen (DE); Guido Flohr, Hurth (DE)

(73) Assignees: Guido Flohr, Hurth (DE); Dietmar Oberhoff, Leichlingen (DE)

(21) Appl. No.: 13/273,804

(22) Filed: Oct. 14, 2011

Related U.S. Application Data
(63) Continuation of application No. PCT/EP2010/054954, filed on Apr. 15, 2010.

(30) Foreign Application Priority Data
Apr. 15, 2009 (DE) 102009017106.1
Apr. 15, 2010 (EP) PCT/EP2010/054954

(51) Int. Cl. G01N 29/04

(52) U.S. Cl. 73/632

(57) ABSTRACT

An ultrasonic testing system for testing a test object that includes at least one transmitting unit and at least one receiver unit. In an embodiment, the transmitting unit generates a spark gap which generates an ultrasonic vibration either on the surface of, or within, the test object. In particular embodiment, the at least one receiver unit optically measures the vibration of the surface of the test object. Embodiments of the invention also relate to a transmitting means and to a receiving system for an ultrasonic testing system and to a method for operating an ultrasonic testing system.

### CROSS-REFERENCE TO RELATED PATENT APPLICATIONS

This patent application is a continuation of PCT/EP2010/054954, filed Apr. 15, 2010, which claims priority to German Application No. 102009017106.1, filed Apr. 15, 2009, the entire teachings and disclosure of which are incorporated herein by reference thereto.

### FIELD OF THE INVENTION

The invention generally relates to ultrasonic testing systems.

### BACKGROUND OF THE INVENTION

Embodiments of the invention represent an improvement over the state of the art with respect to ultrasonic testing systems. These and other advantages of the invention, as well as additional inventive features, will be apparent from the description of the invention provided herein.

### BRIEF SUMMARY OF THE INVENTION

Embodiments of the invention relate to an ultrasonic testing system comprising at least one transmitting unit and at least one receiver unit, to a transmitting apparatus for an ultrasonic testing system for testing a test object, comprising at least one transmitting unit, to a receiving system for an ultrasonic testing system for testing a test object, comprising a laser for illuminating at least two measurement areas on the surface of the test object and comprising at least two receiver units for optically measuring the vibration of the surface of the test object and to a method for operating an ultrasonic testing system.

In the context of quality management of steel and other metallic products, the methods of non-destructive ultrasonic testing and measurement engineering reveal a substantial potential for quality improvement. In the case of ultrasonic testing, an ultrasonic wave is generated in the test body and strip thickness and possibly imperfections in the material or on the surface of the test body can be established from the run time of the sound signal and interfering signals which may occur, in particular echoes from defects. A reliable online testing of this type for possible internal and superficial defects or of the wall thickness measurement during the production process leads to a great economic advantage. Information ascertained early on about the state of the product not only ensures the quality of the finished product, but also permits production-management measures, as a result of which productivity and quality can be substantially increased during further processing and the safety of the staff during the production process can be enhanced.

In the case of hot or fast-moving products, conventional testing using piezoelectric ultrasonic probes is not possible. Alternative methods such as laser ultrasonics or electro-magnetic-acoustic transducers (EMAT test method) are either very expensive or, in the case of free ultrasonic waves, are not sensitive enough.

When testing cold materials, for example in heavy plate testing, this test is conventionally carried out using a very large number of piezoelectric probes with a water gap probe-to-specimen contact. The expense in terms of apparatus or electronics is very high in this case. As a result of, for example spots of grease or oil on the surface or due to other impurities or to uneven surfaces, the probe-to-specimen contact can break off or change, which leads more frequently to pseudo error indications.

Typical parameters of rolled heavy plates are:
Material: carbon and low-alloy high-strength steels
Plate thickness: 5 mm-80 mm, in particular also up to 100 mm or 150 mm
Plate width: 1,000 mm-3,600 mm
Plate length: 5,000 mm-36,000 mm
Plate temperature: approximately 5° C.-110° C.
Plate bend: approximately 15 mm/1 m-50 mm/1 m
Test speed: max. 1 m/s
Surface characteristic: under production conditions, it is possible for many different surface defects to develop, for example rough areas, slightly rippled unevennesses, spots of oil and grease, areas of rust etc. which can lead to error indications, in particular up to approximately 95%, during ultrasonic testing using the piezoelectric test method. As will be explained below, laser-optical ultrasonic transmitting and receiving systems may be used for specific problems in the ultrasonic material testing or ultrasonic wall thickness measurement of metallic material.

The term “laser ultrasound” is understood as meaning a contact-free ultrasonic measuring and testing method, characterised by ultrasonic excitation by means of a short laser pulse in connection with the optical—generally interferometric—detection of the ultrasonic deflection. When a laser pulse of typically a few nanoseconds duration strikes the surface of a material, part of its energy is absorbed while the rest is transmitted or reflected. Most of the absorbed energy is converted into heat, but a small amount is transported away in the form of an ultrasonic wave.

A distinction is made between two different excitation mechanisms: thermoelastic excitation and excitation by pulse transmission. Thermoelastic ultrasonic excitation can be fully explained by local absorption, heating and thermal expansion. It determines the ultrasound source when there is low laser pulse intensity. If the intensity is increased, adhering layers peel off, the material evaporates and plasma forms. This is the excitation mechanism with the greatest practical significance, where the influence of the surface in the case of steel remains restricted to a layer in the micrometer range. The ultrasonic vibrations generated by laser pulses are characterised by a complex spatial and temporal structure. During excitation by impulse transmission, longitudinal pulses of a high bandwidth are mainly generated which spread out vertically to the surface and are reflected in a known manner as a pulse-echo sequence in the workpiece. The surface vibrations in the normal direction can then be measured interferometrically, by using the Doppler effect, as phase or frequency modulation. In other words, the surface vibrations in the normal direction result in a phase or frequency modulation of the light due to the Doppler effect and can be converted interferometrically into an amplitude-modulated signal which can be measured by a photodetector.

A large number of different types of interferometers are suitable for detecting the ultrasonic deflections which are typically within a range of a few angstroms to nanometers. However, the speckle effects which are inevitably associated with laser irradiation greatly limit the choice on industrial surfaces. Delay time interferometers and Fabry-Perot interferometers have hitherto been available for fast-moving surfaces. The delay time interferometer is very large and is thus difficult to use in practice.

This type of ultrasonic transformation provides the following essential advantages over widely-used piezoelectric ultrasonic transducers:
testing or wall thickness measurement can be carried out in a contact-free manner
no coupling medium is required
fast-moving material can be tested
hot material can be investigated
since the sound arises on the surface of the material itself and the vibration of the surface is detected, the coupling problems which occur when conventional piezoelectric ultrasonic transducers are used, are avoided.

The basic disadvantages over widely-used piezoelectric ultrasonic transducers are:
The transmission repetition rate is low and is, for example below 100 Hz.
The sensitivity of the systems is lower compared to piezoelectric ultrasonic transducers.
The price of a single-channel test system is very high.

The efficiency of transforming optical energy into ultrasonic energy is very poor. Therefore, the power, for example 360 mJ/transmission pulse, of the transmission lasers in the known systems has to be very high, meaning the pulse repetition rate is low, for example below 100 Hz, because the available laser power is distributed over the generated transmission pulses. Thus, when laser-laser-ultrasound systems are used, signals are received which have a poor signal/noise ratio at a low pulse repetition rate.

Particular embodiments of the invention involve the development of a new test and measurement method which, on the one hand, avoids the problems which occur in the known methods and on the other hand is relatively economical to produce.

According to a first teaching, this objective is achieved by the subject-matter described herein, advantageous embodiments of which are reproduced in the subclaims and in the following description.

According to embodiments of the invention, it has been found that the transmitting unit in an ultrasonic testing system generates a spark gap which generates an ultrasonic vibration on the surface and/or in the test object, and that the receiver unit optically measures the vibration of the surface of the test object.

A spark gap, i.e., plasma produced by an electric discharge, is generated to produce the ultrasound. The spark gap is ignited and transmitted between the transmitting unit and the surface of the test object. The plasma of the spark gap, produced during the discharge, impacts on the surface and generates the pressure pulse required for the ultrasonic measurement on the surface.

For this, the transmitting unit has at least one ignition coil and an electronic control system for igniting the ignition coil at predetermined times. The electronic system required for this purpose, in particular an ignition coil or an ignition capacitor and electronic control system can be produced very economically and thus can be configured in multiple ways. The efficiency of the transformation from electrical energy into ultrasonic energy is much better compared to the transformation of optical energy into ultrasonic energy. For this reason, a multitude of transmitting units, in particular more than 100 transmitting units can be used in order to achieve a sufficiently large test width.

The electromagnetic pulse generated during transmission does not adversely affect the optical system of the receiver unit and thus it can be combined effectively with the spark gap. The light of the spark can preferably be shadowed by a suitable screen between the strike region of the spark and the measurement area of the optical receiver unit to reduce any influence on the measurement.

For receiving the ultrasound, a commercially available laser-ultrasonic receiving system can be used in particular which is characterized in that an illumination laser is provided, the light of which illuminates the surface in a measurement area, the receiver unit receiving light which is incident in the receiver unit from the measurement area. In particular, a multitude of receiver units can be provided, in particular more than 100 receiver units. Thus greater test widths can also be obtained, the multitude of receiver units preferably being adapted to the multitude of transmitting units.

A preferred embodiment is characterized by an illumination laser and measurement areas, where a measurement area is associated with a respective receiver unit, so that the receiver unit receives light which is incident in the receiver unit from the measurement area, a light guiding system radiating the light of the laser in a first position of the light guiding system into a first measurement area and radiating the light of the laser in a second position of the light guiding system into a second measurement area. Thus, it is possible for two or more, in particular approximately 100 measurement areas to be used with an arrangement that includes an illumination laser and a receiver unit.

If, for example in thick plate testing, many receiving channels are to be used, a light guiding system can split the light of the laser and radiate it into one measurement area and into another measurement area, in particular into many different measurement areas. In this respect, a laser-ultrasonic receiving system can be connected to many receiving lenses via optical multiplexers or matrix switches with optical fibers.

In a further preferred manner, the receiver unit comprises an interferometer, or a light guiding system transmits light, which is incident in the receiver unit, to an interferometer.

If a transmitting system with a relatively high efficiency is used, for example a spark gap, the primary power of the transmitting system can be much smaller, the pulse repetition rate can be increased and the system costs can be significantly reduced. Thus, overall during the construction of many economically-priced, parallel transmitting systems and during the sequential use of a laser-ultrasonic receiving system, it is possible to realise a very much higher sampling rate with many parallel test tracks and relatively low costs per test channel.

Laser-optical ultrasonic receiving systems operate with illumination lasers, for the most part Nd: YAG lasers, in continuous wave mode with a relatively low power of approximately 500 mW −2 W.

The receiving system can be expensive with a single test channel, i.e. a receiver unit which considers only a single measurement area, compared to the conventional ultrasound method. Due to the use of optical multiplexers, it is possible to use a laser-optical ultrasonic receiving system for N receiving sites or receiver units. This allows the construction of an economically-priced ultrasonic system because the price per receiving channel or receiver unit is very low.

An estimation of the number of receiving channels per laser-optical ultrasonic receiving system for heavy plate testing produces the following results:
Sound path: max. 2*100 mm
Sound velocity: 5920 m/s
Signal window to be detected: 33.8 μs
   This produces a maximally possible signal repetition rate of approximately 30 kHz when the individual signal windows are attached to one another in a temporally correct manner. If a pulse repetition rate of 100 Hz per test track is assumed, i.e. with a resolution of 10 mm at 1 m/s transport speed, a maximum of 300 parallel test tracks result if the switching time of the optical multiplexer is disregarded. Under these circumstances, it is possible, by an appropriate activation of the transmitters or selection of the corresponding optical multiplexer input, to process 300 test tracks each with a 100 Hz pulse repetition rate using a laser-optical ultrasonic receiving system.

For comparison: conventional piezoelectric test systems operate for example with 288 (GE Inspection Technologies) or 216 (NDT Systems & Services) received tracks each with a 12.5 mm and respectively 16.6 mm track width.

The sensitivity of a Fabry-Perot interferometer receiving system for laser ultrasound, mentioned above, can be described as follows:

$$S N R = K \cdot S \cdot U \cdot \sqrt{\frac{{P}_{det} \cdot η}{λ \cdot B}}$$

$$S N R = signal \text{-} to \text{-} noise ratio$$

$$S = interferometer sensitivity ( < 1 )$$

$$U = ultrasonic surface deflection ( depends on transmitter )$$

$$Pdet = luminous power at detector ( depends on \text{:} size of light collecting lens ; strength of illumination laser ; distance between receiving lens \text{-} surface )$$

$$η = quantum efficiency at detector ( > 50 \% )$$

$$λ = optical wavelength$$

$$B = detection bandwidth$$

$$K = constant$$

The maximum SNR signal is also limited by the noise of the receiving illumination laser. The amplitude noise and the phase noise of the receiving laser are the fundamental noise sources. Fabry-Perot interferometers with one resonator achieve an SNR of approximately 26 dB. Fabry-Perot interferometers with two resonators achieve an SNR of approximately 45 dB, because the amplitude noise can be eliminated by a differential measuring method.

The systems with two resonators can be used for the testing method with an average error susceptibility. The systems with a resonator are in fact only suitable for wall thickness measurement.

Furthermore, a laser-ultrasonic receiving system is known which uses a photorefractive crystal instead of an optical interferometer. The photorefractive effect describes the light-induced refractive index change in photoconductive, electro-optical crystals. This receiving system is particularly suitable for use under operating conditions.

With this type of interferometer it is possible to achieve SNR of approximately 70 dB. The use of a differential detector can eliminate the amplitude noise. Furthermore, the phase noise can be eliminated when the optical path length of the signal and reference beams is the same.

This interferometer can be constructed in a very compact manner, reacts in a less sensitive way to environmental shocks and does not require an active stabilisation.

In order to be able to operate an interferometric receiving system at many receiving sites, suitable optical switches are required.

Optical switches operate by different methods. An electromechanical method operating with microscopically small mirrors, Micro Electromechanical Mirrors (MEM). In this method, the axes of the micro mirrors are tilted.

Another method operates with transparent mirrors. The mirrors can reflect or can let the light signals through as a non-reflecting disc.

Other methods operate purely optically on the basis of optical couplers or optical switching networks, and others operate based on the method of liquid crystals or bubble jets. In the last-mentioned method, during the switching procedure, chambers, so-called bubbles, are filled with a liquid and they have a different refractive index compared to the unfilled chambers.

At present, using these methods, switching times within a range of approximately 10 ms to 20 ps can be achieved.

The desire to integrate destruction-free testing into an early production stage affords considerable financial savings in terms of energy and material and provides product improvements. The pursuit of this trend right up to its logical conclusion in the production of steel products implies testing the product quality as far as possible during the production process.

The described testing method allows continuous and automatic quality testing at a high speed in a harsh industrial environment.

Reliable destruction-free testing of internal and superficial defects before further processing affords significant advantages as part of quality control.

The availability of reliable information about the product quality in an early production stage not only contributes towards the quality of the final product, but also forms a basis for establishing optimised production parameters which can significantly increase the productivity and quality in further processing.

Possible applications are:
Wall thickness measurement for many measurement tracks during production, for example during pipe production.
Ultrasonic error checking and wall thickness measurement on heavy plates and on in particular hot or fast-moving material, which is difficult to test, during production, for example in billet or forged part production.
Improving the coupling conditions in many testing tasks and, as a result, reducing the pseudo error indications, for example in heavy plate testing.

As a result of the contactless testing and omission of a coupling medium, it is possible to significantly reduce the mechanical outlay, for example in heavy plate testing and this also presents an enormous potential for savings.

The improved measuring and testing method makes it possible for the production processes to be carried out within relatively narrow limits, which will lead to an increase in quality and a greater output. The latter is one of the most efficient methods for increasing the sustainability of industrial products, since as a result, less material has to be produced and thus raw material and energy are saved and emissions are prevented. The development can be used by all steel manufacturers and producers of nonferrous metals.

The objective outlined above is achieved according to advantageous embodiments which are reproduced in the following description.

According to embodiments of the invention, the transmitting apparatus for an ultrasonic testing system for testing a test object is configured with at least one transmitting unit so that the transmitting unit comprises means for generating a spark gap, the spark gap generating an ultrasonic vibration on the surface and/or in the test object.

The generation of ultrasound by spark transmission onto the test object is more effective, because the production as well as the operation of the transmitting apparatus is cheaper compared to the method of laser-ultrasound generation or piezo-ultrasound generation known from the prior art. The strong pulse of the plasma of the spark can be controlled very precisely and both the time and duration can be set exactly. In this respect, the accuracy of the switching time and the switching duration can be adjusted within wide limits.

The transmitting unit preferably comprises an ignition coil and an electronic control system for igniting the ignition coil at predetermined times. This embodiment of the transmitting unit can be advantageously connected on the low voltage side, so that the electronic system outlay is low.

Likewise, the transmitting unit can also comprise an ignition capacitor and an electronic control system for charging and discharging the ignition capacitor at predetermined times. Although in this case the high voltage has to be quickly switched, which necessitates a greater expense, the switching accuracy is further increased by the configuration.

The objective outlined above is achieved according to advantageous embodiments which are reproduced in the following description.

According to embodiments of the invention, the receiving system for an ultrasonic testing system for testing a test object comprises a laser for illuminating at least two measurement areas on the surface of the test object and at least two receiver units for optically measuring the vibration of the surface of the test object. Furthermore, an interferometer and a receiving light guiding system are provided, said receiving light guiding system, in different positions, guides light in each case from different measurement areas onto the interferometer. In this respect, the interferometer and the receiving light guiding system form a receiver unit in respectively one of the positions.

In this configuration of the receiving system, a multi-channel arrangement is realised in that a part of the receiving light guiding system is associated in one position with each measurement area. Thus, this part can be selectively controlled so that in this position of the receiving light guiding system, the light which is picked up is guided onto the interferometer. The light guiding system may include any optical components, for example mirror arrangements.

Preferably provided are at least two light guides which each capture one of the measurement areas and an optical switch is provided which can guide light from respectively one of the light guides onto the interferometer. Depending on the position of the optical switch, the light picked up by a light guide from a specific measurement area is then guided onto the interferometer. By switching over the optical switch, it is then possible for the different measurement areas to be detected in succession, the same interferometer being used in each case. This type of multiplexing makes it possible to successively survey a large number of measurement areas.

As stated above, under these circumstances, it is possible, by an appropriate control of the optical multiplexer, to process for example 300 test tracks each with a 100 Hz pulse repetition rate using a laser-optical ultrasonic receiving system.

In a further preferred configuration of the previously described receiving system, a light guiding system radiates the light of the laser in different positions into different measurement areas. Similarly to the situation on the detection side of the receiving system, the laser light can be guided by a light guiding system onto the test body such that laser light is only radiated onto that measurement area from which light is currently also received by the receiving light guiding system. Thus, the laser power can be intentionally employed where the light is used. Consequently, either an overall lower laser power can be used, or an available laser power can be used more effectively. In this case as well, the light guiding system may include any optical components, for example mirror arrangements.

In the described receiving system, at least two light guides are preferably used which are associated with one of the measurement areas each, and an optical switch guides the laser light selectively into each one of the light guides. This effectively operating illumination system can distribute the laser light by fast switching procedures such that, for example, it is possible to process the above-mentioned 300 test tracks each with a 100 Hz pulse repetition rate.

The previously described transmitting apparatus according to the second teaching of the present invention and the receiving system according to the third teaching of the present invention can be used together in an ultrasonic testing system of the type described above. Through the use of two coordinated optical systems which in particular allow an optical multi-channel system by means of optical switches, it is possible to test large bandwidths at fast running times.

Embodiments of the invention also relate to a method for operating a previously mentioned ultrasonic testing system according to embodiments of the invention, in which method ultrasonic waves are generated by means of spark gaps in a test body using a transmitting apparatus comprising at least two parallel-operating transmitting units, in which method the ultrasonic signal is measured by a receiving system comprising at least two optical receiver units, in each case one transmitting unit and one receiver unit are associated with one another, the mutually associated transmitting unit and receiver unit are activated under temporal coordination with one another, and a grid of measured points is surveyed by a serial activation of the transmitting apparatus and the receiver unit on the test body.

Further features and advantages of the system and method described herein are provided in the preceding and following description.

### BRIEF DESCRIPTION OF THE DRAWINGS

In the following, the invention will be described in more detail, while referring to the accompanying drawings, in which:

FIG. 1, shows an exemplary embodiment of an ultrasonic testing system according to an embodiment of the invention with a transmitting apparatus according to an embodiment of the invention and a receiving system according to an embodiment of the invention; and

FIGS. 2-4, show graphic illustrations of measuring signals.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

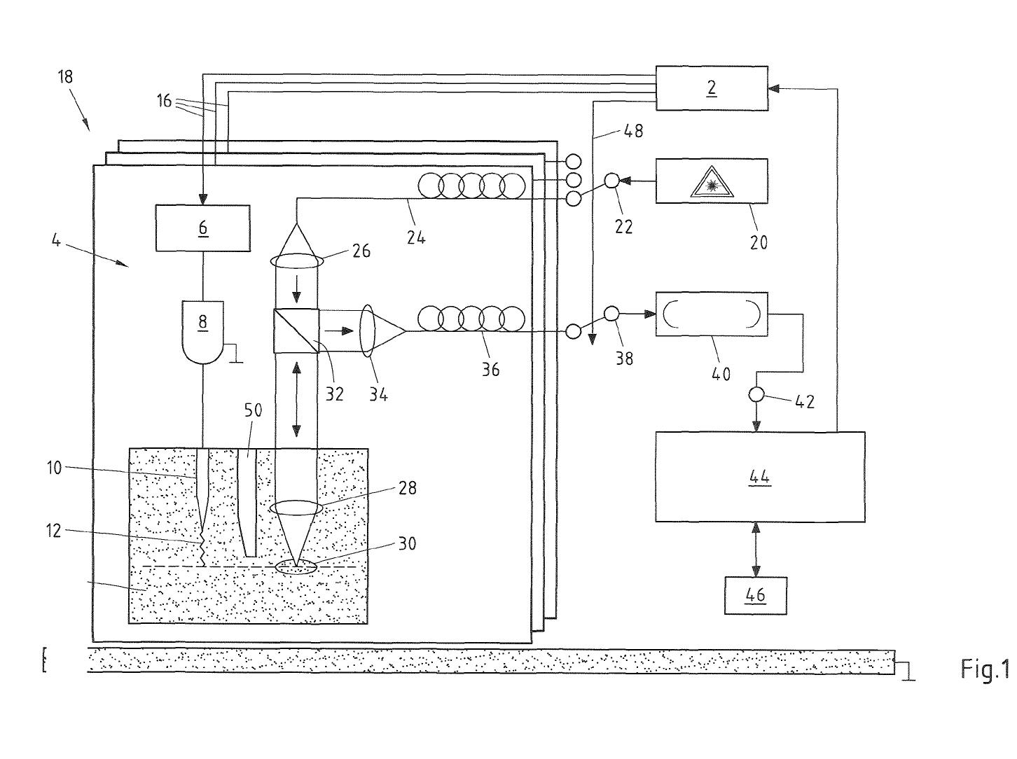

FIG. 1 shows an ultrasonic testing system according to an embodiment of the invention which is provided with a transmitting apparatus, according to an embodiment of the invention, and a receiving system, according to an embodiment of the invention. Furthermore, a method, according to an embodiment of the invention, can be carried out using this ultrasonic testing system.

The measuring arrangement illustrated in FIG. 1 firstly comprises a control 2 which performs and coordinates the control of the components, described in the following, of the ultrasonic testing system.

First of all, the mode of operation of a transmitting apparatus 4 for an ultrasonic testing system for testing a test object will be explained. The transmitting apparatus 4 comprises transmitting electronics 6, an ignition coil 8 and an electrode 10 which together form a transmitting apparatus. The ignition coil 8, together with the electrode 10, presents means for generating a spark gap 12, wherein the spark gap 12 generates an ultrasonic vibration on the surface and/or within the test object 14.

The control 2 transmits a control signal to the transmitting electronics 6 via a line 16, as a result of which a precise temporal sequence, in particular with regard to the ignition time and ignition duration, is achieved for generating the spark gap 12. The transmitting electronics 6 interrupts the direct current on the primary side of a transformer arranged in the ignition coil, as a result of which a voltage sufficient for generating the spark gap 12 is generated on the secondary side by the breaking-down magnetic field.

Instead of an ignition coil arrangement, it is also possible to provide an ignition capacitor, although the voltage generated by the control electronics 6 must be sufficient per se in order to charge the capacitor to such an extent that it can ignite the spark gap.

In FIG. 1, three schematic planes 18 indicate that a multitude of transmitting units is arranged parallel next to one another. In this respect, the term “plane” is not to be understood as meaning that those arranged there are arranged geometrically in one plane, but that each “plane” comprises a separate arrangement and the different arrangements are arranged parallel to one another.

Provided in each plane 18 are transmitting electronics 6, an ignition coil 8 and an electrode 10 which are controlled by the control 2 via one of the lines 16. Thus, the transmitting units arranged in parallel to one another can generate in series spark gaps 12 to induce ultrasonic pulses at different points on the surface of the test body 14.

According to embodiments of the invention, the transmitting apparatus can include one or more transmitting units, depending on the requirements imposed on the test body to be measured.

FIG. 1 also shows a receiving system for an ultrasonic testing system. A laser 20 generates a laser beam which is inducted by an optical switch 22 into a light guide 24, or an optical waveguide (OWG). The light guide 24 transmits the light onto a measurement area 30 in a first plane 18 by means of a suitable optical system 26 and 28.

The light reflected from the measurement area 30 is coupled out of the light path by a beam splitter 32 and is inducted into a light guide 36 by a suitable lens 34. An optical switch 38 then couples the light out of the light guide 36 and inducts it into an interferometer 40. A detector 42 generates an output signal which is transmitted into an evaluation unit 44. There, the signal is evaluated in the conventional manner with A/D transformation and real time signal processing, the result of which is transferred to a computer 46.

If a surface vibration occurs, for example due to an ultrasonic wave spreading out in the test body, then a Doppler shift of the reflected light takes place in particular in the normal direction. These phase- or frequency-modulated light vibrations are then transformed interferometrically into an amplitude-modulated signal which can be measured by a photodetector.

The previously described construction is provided in a large number of planes 16, in each of which a previously described receiver unit is arranged in order to be able to capture a multitude of measurement areas 30. The control 2 then controls via a line 48 the two optical switches 22 and 38 such that they assume different positions. Thus the laser light is inducted into the light guide 24 at the same time as the reflected light, picked up by the light guide 36, is guided onto the interferometer 40. Therefore, both light guides 22 and 38 are “active” at the same time. By an alternating switching to of the respective light paths and thus of the adjacently arranged receiver units, a multiplexing of the receiving system is thus achieved.

FIG. 1 also shows the cooperation of the transmitting apparatus and the receiving system of the ultrasonic testing system.

The control 2 takes over the synchronisation of the transmitting apparatus and the receiving system. At a predetermined time, the transmitting electronics 6 is activated in one of the planes 18 in order to generate by means of the ignition coil 8 and the electrode 10 a spark gap 12 with a defined start and finish time. The spark gap 12 induces an ultrasonic pulse in the test body 14.

Preferably at the particular moment in time when the spark gap 12 is generated, but in any case at a time with a defined time interval to it, the receiving system and in particular the optical switches 22 and 38 are activated such that the receiving system is active in the same plane 18 and measures a surface vibration based on the ultrasonic signal. The components of the receiving system in the respective plane 18 are left switched to active until a period of time has elapsed which is long enough for a run time measurement. This time period depends on the material parameters and on the thickness of the test body and is, for example 30 to 50 μs.

Thus, both the transmitting apparatus and the receiving system can be activated in different planes successively in time. Due to the time sequence of the activation of the planes, adjacently located measurement areas can be captured. Thus a grid of measurement areas is detected successively. If the test body moves transversely to the arrangement of the planes or if the transmitting and receiving systems move over the body to be tested and if the width of the arrangement of the planes or the movement amplitude of the transmitting and receiving systems substantially corresponds to the width of the test body, then the entire test body can be successively examined in a narrow grid of measurement areas.

FIG. 1 also shows that a screen 50 is provided between the spark gap 12 and the measurement area 30, which screen 50 screens the intensive light, occurring during generation of the spark gap 12, from the measurement area 30.

In addition, the signal-to-noise ratio can be further improved by the use of suitable optical band filters which preferably only allow through the wavelength range of the laser light. For example, such an optical filter can be arranged between the beam splitter 32 and the lens 34.

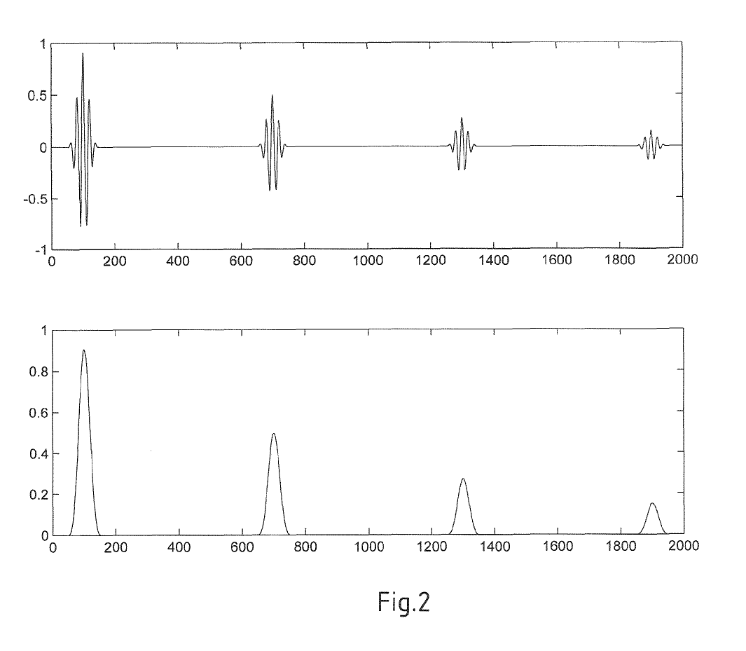

FIGS. 2 to 4 show examples of signals which are recorded during a run time measurement. The output signal of the interferometer is shown at the top in each case, while the lower curve shows the envelope (for example the quadrature-demodulated signal or the low pass-filtered course of the upper measurement curve). The labelling of the x-axis of the diagrams represents the sampling points of the signal which correspond to an arbitrary unit of time. The y-axis represents the respective intensity of the curve in arbitrary units.

FIG. 2 shows an idealised, noise-free and undisturbed signal. A vibration can be seen at regular intervals, the amplitude of which becomes smaller from one incidence to the next. These vibrations are generated by the ultrasonic signal which is repeatedly reflected on the surface of the test body opposite the observed surface. As a result of repeatedly passing through the test body, the amplitude of the signal decreases. The signal path shown in FIG. 2 is undisturbed, because only the regularly occurring vibration signals arise.

The thickness of the test body can be calculated from the intervals of the maxima in the lower curve, when the speed of sound inside the test body is known.

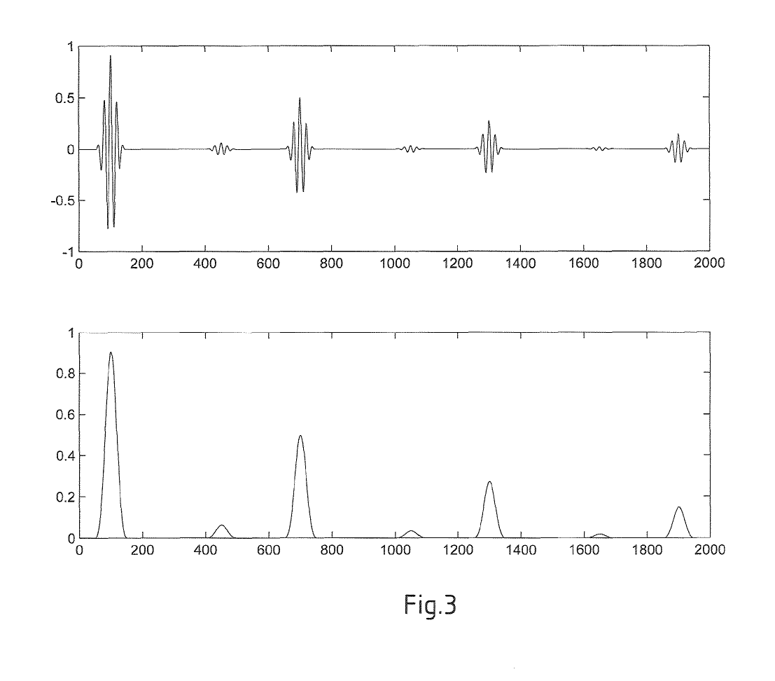

FIG. 3 shows an idealized, noise-free signal which this time is disturbed. It is possible to see at regular intervals firstly a vibration, as in FIG. 2, the amplitude of which becomes smaller from one incidence to another. Between each pair of vibration cycles, there are respectively smaller signals, which indicates a shorter run time of the ultrasonic signal inside the test body. Such an additional signal can be the result of a disturbance inside the test body which produces a reflection of the ultrasonic wave in the region between the two surfaces. Thus, this additional signal or its frequency and amplitude of occurrence can be used as a measure of the quality of the test body.

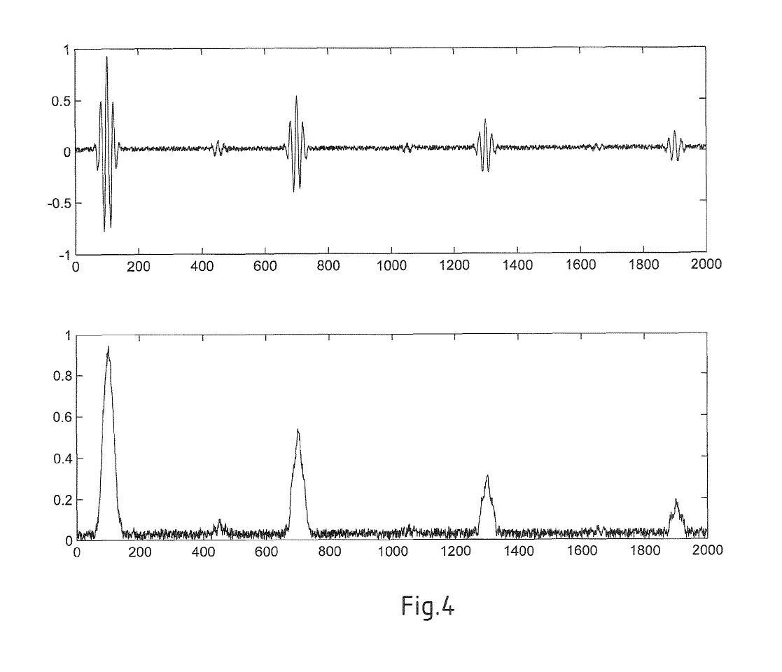

Finally, FIG. 4 shows the signal represented in FIG. 3 with a superimposed noise, so that these measurement curves represent a realistic case. It should be recognised that the determination of the maxima is complicated by the noise. For this reason, when the interferometer is selected, attention must always be paid to the signal-to-noise ratio to be achieved thereby.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An ultrasonic testing system for testing a test object comprising:
at least one transmitting unit and a multitude of receiver units, wherein each receiver unit optically measures the vibration of a surface of the test object;
an illumination laser is provided, the light of which illuminates the surface in a measurement area, wherein one of the multitude of receiver units receives light which is incident in that receiver unit from the measurement area, wherein the measurement area is associated with a respective receiver unit, so that the one of the multitude of receiver units receives light which is incident in the receiver unit from the measurement area;
a light guiding system which radiates the light of the laser in a first position of the light guiding system into a first measurement area and in a second position of the light guiding system into a second measurement area, wherein the light guiding system splits the light of the laser and radiates it into the first measurement area and into the second measurement area;
further comprising a multitude of transmitting units, wherein each transmitting unit generates a spark gap, and wherein the spark gap generates an ultrasonic vibration on the surface of, or within, the test object.

2. The ultrasonic testing system according to claim 1, wherein each transmitting unit comprises an ignition coil and control electronics for igniting the ignition coil at predetermined times.

3. The ultrasonic testing system according to claim 2, wherein each receiver unit comprises an interferometer or a light guiding system that transmits light, which is incident in the receiver unit, to an interferometer.

4. The ultrasonic testing system according to claim 1, wherein each receiver unit comprises an interferometer or a light guiding system that transmits light, which is incident in the receiver unit, to an interferometer.
